(19) United States
(12) Patent Application Publication
(10) Pub. No.: US 2026/0105910 A1
(43) Pub. Date: Apr. 16, 2026

(54) Audio identification system and audio categorization apparatus and method thereof

(71) Applicant: REALTEK SEMICONDUCTOR CORPORATION, HSINCHU (TW)

(72) Inventor: YING-YING CHAO, HSINCHU (TW)

(21) Appl. No.: 19/354,018

(22) Filed: Oct. 9, 2025

(30) Foreign Application Priority Data
Oct. 14, 2024 (TW) 113139046

(51) Int. Cl. G10L 15/14; G10L 15/06; H04R 25/00; G10L 15/02

(52) U.S. Cl. CPC G10L 15/14; G10L 15/063; H04R 25/505; G10L 15/02

(57) ABSTRACT

An audio categorization method is provided that includes steps outlined below. From a plurality of training audio files categorized into a plurality of audio categories, one of the audio categories is selected to be a corresponding audio category and the training audio files categorized in to the corresponding audio category is retrieved so as to perform audio framing and feature extraction thereon to generate a plurality of training feature data. A Gaussian mixture model training is performed on the training feature data to generate a plurality of Gaussian distribution curves to approximate a data distribution of the training feature data. A plurality of curve parameters of the Gaussian distribution curves are generated to be a categorizing feature of the corresponding audio category.

### BACKGROUND OF THE INVENTION

### 1. Field of the Invention

The present invention relates to an audio identification system, an audio categorization apparatus and an audio categorization method thereof.

### 2. Description of Related Art

Some electronic apparatuses may execute different functions according to the sounds in the environment that the electronic apparatuses reside. However, when different sources of the sounds exist in the environment, the electronic apparatuses receive various kinds of sounds. If the electronic apparatuses are not equipped with audio categorization mechanism that can accurately identify the category of the audio signals, the predetermined functions cannot be executed at the proper timing.

### SUMMARY OF THE INVENTION

In consideration of the problem of the prior art, an object of the present invention is to supply an audio identification system, an audio categorization apparatus and an audio categorization method thereof

The present invention discloses an audio categorization apparatus that includes a storage circuit and a categorization processing circuit. The storage circuit is configured to store a plurality of training audio files categorized into a plurality of audio categories. The categorization processing circuit is configured to select one of the audio categories as a corresponding audio category and retrieve the training audio files categorized to be the corresponding audio category to perform an audio framing and a feature extraction on the training audio files to generate a plurality of pieces of training feature data, perform a Gaussian mixture model (GMM) training on the training feature data to generate a plurality of Gaussian curves approximating a data distribution of the training feature data and generate a plurality of curve parameters of each of the Gaussian curves to be a categorizing feature of the corresponding audio category.

The present invention also discloses an audio categorization method that includes steps outlined below. One of a plurality of audio categories is selected as a corresponding audio category from a plurality of training audio files categorized into a plurality of audio categories and the training audio files categorized to be the corresponding audio category are retrieved to perform an audio framing and a feature extraction on the training audio files to generate a plurality of pieces of training feature data. A Gaussian mixture model training is performed on the training feature data to generate a plurality of Gaussian curves approximating a data distribution of the training feature data. A plurality of curve parameters of each of the Gaussian curves are generated to be a categorizing feature of the corresponding audio category.

The present invention further discloses an audio identification system that includes an audio categorization apparatus and an audio identification apparatus. The audio categorization apparatus includes a storage circuit and a categorization processing circuit. The storage circuit is configured to store a plurality of training audio files categorized into a plurality of audio categories. The categorization processing circuit is configured to select one of the audio categories as a corresponding audio category and retrieve the training audio files categorized to be the corresponding audio category to perform an audio framing and a feature extraction on the training audio files to generate a plurality of pieces of training feature data, perform a Gaussian mixture model training on the training feature data to generate a plurality of Gaussian curves approximating a data distribution of the training feature data and generate a plurality of curve parameters of each of the Gaussian curves to be a categorizing feature of the corresponding audio category. The audio identification apparatus includes an audio retrieving circuit and an identification processing circuit. The audio retrieving circuit is configured to retrieve an input audio. The identification processing circuit is configured to perform the audio framing and the feature extraction on the input audio to generate a plurality of pieces of audio feature data, compare the audio feature data of a plurality of to-be-identified sections of the input audio with the categorizing feature of all the audio categories to determine one of the audio categories that each of the to-be-identified sections belongs to and perform a statistics on the to-be-identified sections according to the audio categories that the to-be-identified sections belong to, so as to select one of the audio categories that most of the to-be-identified sections belong to as an identified audio category.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a circuit diagram of an audio identification system according to an embodiment of the present invention.

FIG. 2 illustrates a diagram of a plurality of audio frames based on the audio framing performed on the training audio file by the categorization processing circuit according to an embodiment of the present invention.

FIG. 3 illustrates a diagram of a data distribution and Gaussian curves of the training feature data according to an embodiment of the present invention.

FIG. 4 illustrates a flow chart of an audio categorization method according to an embodiment of the present invention.

### DETAILED DESCRIPTION OF THE PREFERRED EMBODIMENTS

An aspect of the present invention is to provide an audio identification system, an audio categorization apparatus and an audio categorization method thereof to perform an audio framing and a feature extraction on training audio files with different audio categories to generate categorizing features such that audio feature data of to-be-identified sections in an input audio signal can be compared with the categorizing features and a statistic can be performed on the comparing results to determine the identified audio category of the input audio signal.

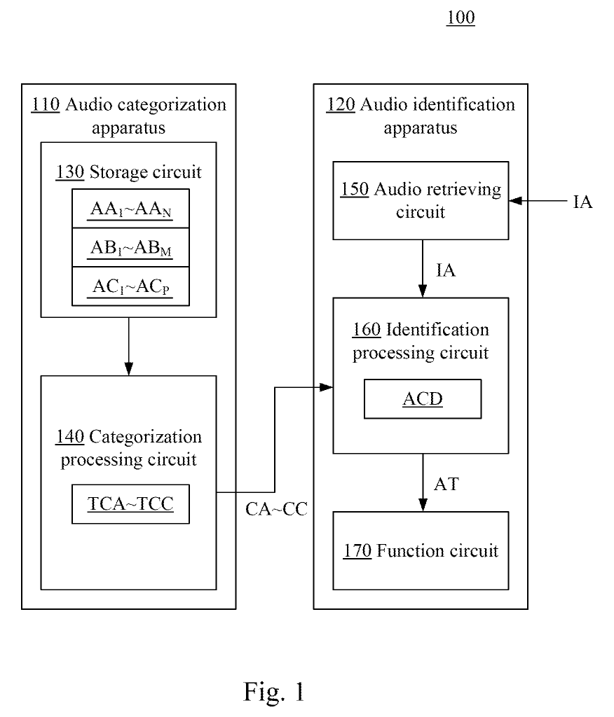

Reference is now made to FIG. 1. FIG. 1 illustrates a circuit diagram of an audio identification system 100 according to an embodiment of the present invention. The audio identification system 100 includes an audio categorization apparatus 110 and an audio identification apparatus 120.

The audio categorization apparatus 110 is configured to perform training on training audio files AA₁~AA_{N}, AB₁~AB_{M} and AC₁~AC_{P} categorized into different audio categories to generate categorizing features CA~CC corresponding to different audio categories.

The audio identification apparatus 120 is configured to retrieve an input audio IA to perform identification according to the categorizing features CA~CC to identify the audio categories of the input audio IA.

The configuration and operation mechanism of the audio categorization apparatus 110 are described first in the following paragraphs.

The audio categorization apparatus 110 includes a storage circuit 130 and a categorization processing circuit 140.

The storage circuit 130 can by any circuit having a data storage mechanism and is configured to store a plurality of training audio files AA₁~AA_{N}, AB₁~AB_{M} and AC₁~AC_{P} categorized into a plurality of audio categories, in which N, M and P are integers that are either the same or different from each other.

In an embodiment, the audio categories include a music category, a speech category and an environmental sound category such that the training audio files AA₁~AA_{N} are categorized to correspond to the music category, the training audio files AB₁~AB_{M} are categorized to correspond to the speech category, and the training audio files AC₁~AC_{P} are categorized to correspond to the environmental sound category. However, the present invention is not limited thereto.

The categorization processing circuit 140 and the storage circuit 130 are electrically coupled. In an embodiment, the categorization processing circuit 140 may access the application programs stored in such as, but not limited to the storage circuit 130 to perform the processing of the audio categorization.

The categorization processing circuit 140 is configured to select one of the audio categories as a corresponding audio category and retrieve the training audio files categorized to be the corresponding audio category to perform an audio framing and a feature extraction on the training audio files to generate a plurality of pieces of training feature data TCA.

For example, the categorization processing circuit 140 may select the music category as the corresponding audio category and retrieve the training audio files AA₁~AA_{N} categorized into the music category.

Subsequently, the categorization processing circuit 140 performs the audio framing according to a frame size and an overlapping size to generate a plurality of audio frames each having the frame size. Each of the audio frames in turn has an actual frame and an overlapping portion having the overlapping size, and the overlapping portion of each of the audio frames includes the signal content that is the same as a front portion of a subsequent audio frame.

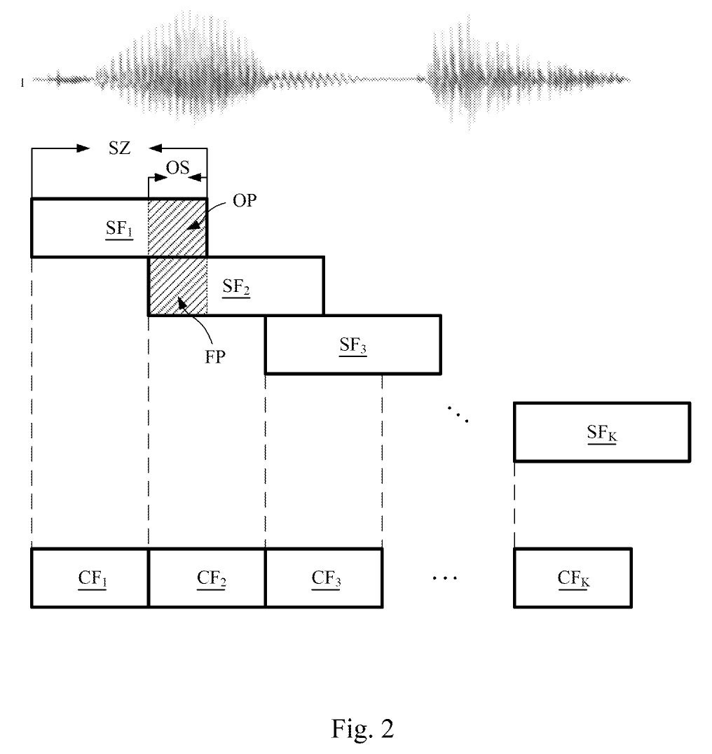

Reference is now made to FIG. 2. FIG. 2 illustrates a diagram of a plurality of audio frames SF₁~SF_{K} based on the audio framing performed on the training audio file AA₁ by the categorization processing circuit 140 according to an embodiment of the present invention.

Each of the audio frames SF₁~SF_{K} has an audio frame size. In FIG. 2, an audio frame size SZ is exemplarily labeled above the audio frame SF₁. In an embodiment, the audio frame size SZ can be determined by a sampling rate and a number of the sampling points within a unit of audio frame. In a numerical example, the sampling rate can be such as, but not limited to 16000 sampling points per second, in which 2048 sampling points are included in one audio frame (e.g., the audio frame SF₁). Under such a condition, the audio frame size is 0.128 seconds.

Each of the audio frames SF₁~SF_{K} in turn has an actual audio frame and an overlapping portion having an overlapping size. Take the audio frame SF₁ as an example, an actual audio frame CF₁ included in the audio frame SF₁ is illustrated below the audio frame SF₁. A block filled with slash lines in the audio frame SF₁ is labeled to be an overlapping portion OP. An overlapping size OS is labeled above the overlapping portion OP. A block filled with slash lines in a subsequent audio frame of the audio frame SF₁, which is the audio frame SF₂, is labeled to be a front portion FP. The overlapping portion OP and the front portion FP have the same signal content.

The disposition of the overlapping portion OP prevents the occurrence of the condition that an incomplete feature is retrieved when the neighboring audio frames are not continuous (i.e., no overlapping portion at all). In a numerical example, the overlapping portion OP may include 512 sampling points. Under such a condition, the overlapping size OS is 0.032 seconds and the size of the actual audio frame CF is 0.096 seconds.

Each of the other audio frames SF₂~SF_{K} may include the configuration identical to the audio frame SF₁. In FIG. 2, only the actual audio frame CF₁~CF_{K} are illustrated below the audio frames SF₁~SF_{K} while the overlapping portion and front portion of any two neighboring frames of the audio frames SF₂~SF_{K} are not illustrated.

The categorization processing circuit 140 performs the feature extraction on the audio frames SF₁~SF_{K} to generate the training feature data TCA including zero-crossing rate (ZCR) data, spectral contrast data, chroma short-time Fourier transform (STFT) data, Mel spectrogram data or a combination thereof.

When each two neighboring sampling points of audio frames SF₁~SF_{K} serve as a set of sampling points, the zero-crossing rate data is a ratio between the sets of sampling points having the values transiting from a negative value to a positive value and from a positive value to a negative value and the total sets of sampling points. Such a feature is used to determine whether audio frames SF₁~SF_{K} belongs to the speech category or the environmental sound category. For each of the audio frames SF₁~SF_{K}, the zero-crossing rate data includes one piece of data.

The spectral contrast data includes a difference between a peak and a valley in each of a plurality of frequency bands of each of the audio frames SF₁~SF_{K}. Such a feature is used to determine whether each of the audio frames SF₁~SF_{K} belongs to the music category. When the audio frames are analyzed based on 7 frequency bands, the spectral contrast data of each of the audio frames SF₁~SF_{K} includes 7 pieces of data.

The chroma short-time Fourier transform data includes a size of each of a plurality of sections, in which the frequency spectrum of each of the audio frames SF₁~SF_{K} is mapped to the sections corresponding to 12 chromatic tones within an octave. Such a feature is used to determine whether each of the audio frames SF₁~SF_{K} belongs to the music category. For each of the audio frames SF₁~SF_{K}, the chroma short-time Fourier transform data includes twelve pieces of data.

The Mel spectrogram data performs analysis on the sampling points of each of the audio frames SF₁~SF_{K} according to the frequency scales simulating the non-linear hearing perception of the human. For each of the audio frames SF₁~SF_{K}, the Mel spectrogram data includes 128 pieces of data.

In the example that the training feature data TCA includes the items described above, the training feature data TCA of each of the audio frames SF₁~SF_{K} includes 1+7+12+128=148 pieces of data. Take the training audio files AA₁~AA_{N} as an example, if N is 50 and the length of each of the training audio files AA₁~AA_{N} is 30 seconds, the number of the audio frames SF₁~SF_{K} is 30/0.096=312 and the number of the pieces of data of the training feature data TCA is 50x312x148=2308800.

However, it is appreciated that the items and the number of data described above are merely an example. In other embodiments, the training feature data TCA in each of the audio frames may include different number of items and different number of data. The present invention is not limited thereto.

The categorization processing circuit 140 performs Gaussian mixture model training on the training feature data TCA to generate a plurality of Gaussian curves approximating a data distribution of the training feature data TCA.

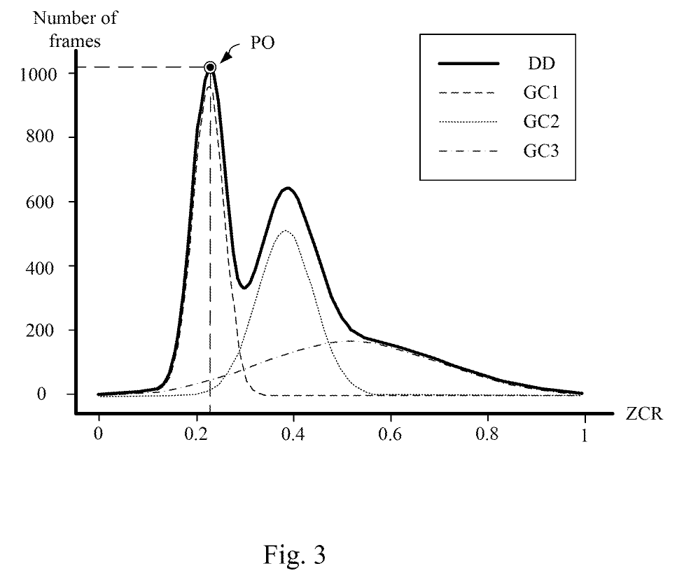

Reference is now made to FIG. 3. FIG. 3 illustrates a diagram of a data distribution DD and Gaussian curves GC₁~GC₃ of the training feature data TCA according to an embodiment of the present invention. In FIG. 3, the X-axis is the zero-crossing rate and the Y-axis is the number of the frames.

In an embodiment, Gaussian mixture model training includes performing a plurality of iterating processes on the training feature data TCA according to a plurality of predetermined Gaussian curves to approximate the training feature data TCA by the categorization processing circuit 140.

As illustrated in FIG. 3, the data distribution DD of the training feature data TCA is not a Gaussian curve. Each of the data points in the data distribution DD represents the number of frames having the corresponding zero-crossing rate. Take the data point PO as an example, such a data point corresponding to the condition that the zero-crossing rate of 1010 frames is 0.225.

The categorization processing circuit 140 may start the iterating processes according to such as, but not limited to 3 predetermined Gaussian curves (not illustrated).

Each of these predetermined Gaussian curves has a predetermined weighting, a predetermined center position and a predetermined covariance matrix. The weighting determines the height of each of the predetermined Gaussian curves. The center position determines the position of the highest point of each of the predetermined Gaussian curves. The covariance matrix determines the dispersion of each of the predetermined Gaussian curves. The categorization processing circuit 140 may calculate the difference between the predetermined Gaussian curves and the data distribution DD and modify the predetermined Gaussian curves to approximate the data distribution DD.

After the iterating processes including a plurality of times of different calculation and modification, the categorization processing circuit 140 may generate the 3 Gaussian curves GC₁~GC₃ approximating the data distribution DD. The setting of the parameter and the number of execution of the iterating processes affects the degree that the Gaussian curves GC₁~GC₃ approximates the data distribution DD.

The categorization processing circuit 140 further generates a plurality of curve parameters of the Gaussian curves GC₁~GC₃ to be the categorizing feature CA of the corresponding audio category. In an embodiment, the curve parameters include the weighting, the center position and the covariance matrix of each of the Gaussian curves GC₁~GC₃.

It is appreciated that the number of the Gaussian curves used to approximate the data distribution DD described above is merely an example. In other embodiments, different number of Gaussian curves can be configured according to the requirements of accuracy or operation resource.

The embodiment described above uses the training audio files AA₁~AA_{N} categorized into the music category as an example. However, the same method can be applied to the training audio files AB₁~AB_{M} categorized into the speech category and the training audio files AC₁~AC_{P} categorized into the environmental sound category to generate the corresponding training feature data TCB and TCC, and further obtain the corresponding categorizing feature CB and CC.

Reference is now made to FIG. 1 again to describe the configuration and the operation mechanism of the audio identification apparatus 120.

The audio identification apparatus 120 includes an audio retrieving circuit 150, an identification processing circuit 160 and a function circuit 170.

The audio retrieving circuit 150 is configured to retrieve the input audio IA. In an embodiment, the audio retrieving circuit 150 can be such as, but not limited to a microphone or other circuits able to perform the audio retrieving.

The identification processing circuit 160 is configured to perform the audio framing and the feature extraction on the input audio IA to generate a plurality of audio feature data ACD.

In an embodiment, the identification processing circuit 160 may perform the audio framing and the feature extraction on the input audio IA based on the same technology used by the categorization processing circuit 140 described in accompany with FIG. 2 to generate a plurality of audio frames, in which each of the audio frames in turn has an actual audio frame and an overlapping portion having the overlapping size. The detail is not described herein. For example, when the length of the input audio IA is 10 seconds and the identification processing circuit 160 perform the audio framing by using the audio frame size and the overlapping size that are the same as those used by the categorization processing circuit 140, the number of the audio frame is 10/0.096=104. The number of the pieces of the data included in the audio feature data ACD in each of the audio frame is 148.

The identification processing circuit 160 compares the audio feature data ACD of a plurality of to-be-identified sections of the input audio IA with the categorizing features CA~CC of all the audio categories to determine one of the audio categories that each of the to-be-identified sections belongs to. In an embodiment, the identification processing circuit 160 may access the categorizing features CA~CC from the audio categorization apparatus 110 when the comparison is performed. In another embodiment, the identification processing circuit 160 may access the categorizing features CA~CC from the audio categorization apparatus 110 in advance and store the categorizing features CA~CC in a storage circuit (not illustrated) included by the audio identification apparatus 120 such that the audio identification apparatus 120 accesses the categorizing features CA~CC from the storage circuit when the comparison is performed.

In an embodiment, each of the to-be-identified sections is the audio frame. For one of the to-be-identified sections to be operated, the identification processing circuit 160 performs a probability density function (PDF) calculation on the audio feature data ACD of the one of the to-be-identified sections to be operated according to the categorizing features CA~CC of each of the audio categories, so as to determine that the one of the to-be-identified sections to be operated belongs to one of the audio categories corresponding to a largest probability density value.

For example, when the identification processing circuit 160 performs the calculation of the probability density function on the one of the to-be-identified sections to be operated, obtains three probability density values corresponding to the music category, the speech category and the environmental sound category and determines that the probability density value corresponding to the music category is the largest probability density value, the identification processing circuit 160 determines that the one of the to-be-identified sections to be operated belongs to the music category.

Subsequently, the identification processing circuit 160 performs a statistics on the to-be-identified sections according to the audio categories that the to-be-identified sections belong to, so as to select one of the audio categories that most of the to-be-identified sections belong to as an identified audio category AT of the input audio IA.

For example, when the identification processing circuit 160 performs the statistics based on the calculation results of the 104 to-be-identified sections to determine that 1 to-be-identified section belongs to the music category, 71 to-be-identified sections belong to the speech category, and 32 to-be-identified sections belong to the environmental sound category, the identification processing circuit 160 determines that the identified audio category AT of the input audio IA is the speech category.

The function circuit 170 is configured to perform a predetermined function according to the identified audio category AT. Different embodiments of the audio identification apparatus 120 are used as examples to describe the operation mechanism of the function circuit 170.

In an embodiment, the audio identification apparatus 120 is a hearing aid apparatus and the function circuit 170 is an equalization circuit to perform a speech enhancing function when the identified audio category AT is a speech category, to perform an audio enhancing function when the identified audio category AT is a music category and perform a noise reduction function when the identified audio category AT is an environmental sound category.

In another embodiment, the audio identification apparatus 120 is a smart electronic apparatus such as, but not limited to a smart watch, a smart phone, a tablet or an intelligent car system and the function circuit 170 is a control circuit to perform a voice control function, a speech-to-text function or a message notifying function when the identified audio category AT is a speech category and not to perform the voice control function, the speech-to-text function and the message notifying function when the identified audio category AT is a music category or an environmental sound category.

For example, when the audio identification apparatus 120 is an intelligent car system, the function circuit 170 may determine whether a received message includes important information so as to determine the identified audio category AT of the input audio IA when the message includes the important information. When the identified audio category AT is the speech category, the function circuit 170 performs a message notifying function with a first broadcast voice to notify the user whether the message is required to be read under the condition that the user is having a conversion with other people. When the identified audio category AT is the music category or the environmental sound category, the function circuit 170 performs the message notifying function with a second broadcast voice to notify the user that an important message is received. However, the present invention is not limited thereto.

The audio identification system and the audio categorization apparatus thereof of the present invention perform an audio framing and a feature extraction on training audio files with different audio categories to generate categorizing features such that audio feature data of to-be-identified sections in an input audio signal can be compared with the categorizing features and a statistic can be performed on the comparing results to determine the identified audio category of the input audio signal.

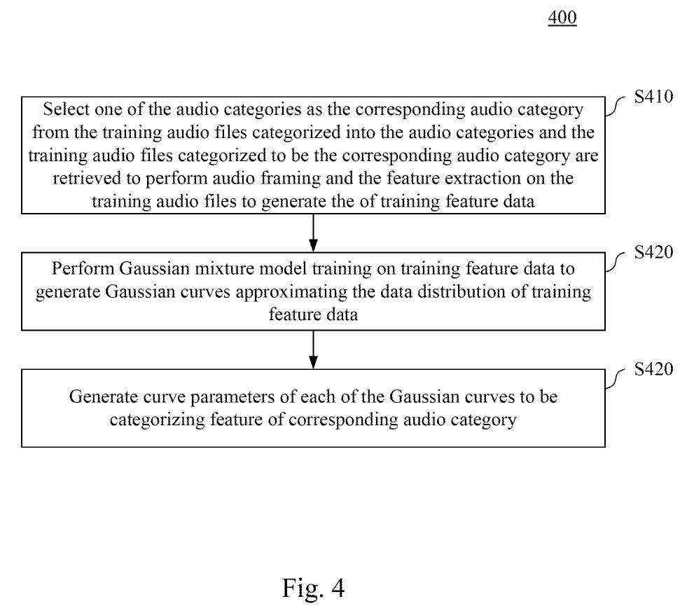

Reference is now made to FIG. 4. FIG. 4 illustrates a flow chart of an audio categorization method 400 according to an embodiment of the present invention.

In addition to the apparatus described above, the present disclosure further provides the audio categorization method 400 that can be used in such as, but not limited to, the audio categorization apparatus 110 in FIG. 1. As illustrated in FIG. 4, an embodiment of the audio categorization method 400 includes the following steps.

In step S410, one of the audio categories is selected as a corresponding audio category from the training audio files AA₁~AA_{N}, AB₁~AB_{M} and AC₁~AC_{P} categorized into the audio categories and the training audio files AA₁~AA_{N}, AB₁~AB_{M} and AC₁~AC_{P} categorized to be the corresponding audio category are retrieved to perform the audio framing and the feature extraction on the training audio files to generate the of training feature data TCA~TCC.

In step S420, the Gaussian mixture model training is performed on the training feature data TCA~TCC to generate the Gaussian curves GC₁~GC₃ approximating the data distribution DD of the training feature data TCA~TCC.

In step S430, the curve parameters of each of the Gaussian curves GC₁~GC₃ are generated to be the categorizing feature CA~CC of the corresponding audio category.

It is appreciated that the embodiments described above are merely an example. In other embodiments, it should be appreciated that many modifications and changes may be made by those of ordinary skill in the art without departing, from the spirit of the disclosure.

In summary, the present invention discloses the audio identification system, the audio categorization apparatus and the audio categorization method thereof perform an audio framing and a feature extraction on training audio files with different audio categories to generate categorizing features such that audio feature data of to-be-identified sections in an input audio signal can be compared with the categorizing features and a statistic can be performed on the comparing results to determine the identified audio category of the input audio signal.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. An audio categorization apparatus comprising:
a storage circuit configured to store a plurality of training audio files categorized into a plurality of audio categories; and
a categorization processing circuit configured to:
select one of the audio categories as a corresponding audio category and retrieve the training audio files categorized to be the corresponding audio category to perform an audio framing and a feature extraction on the training audio files to generate a plurality of pieces of training feature data;
perform a Gaussian mixture model (GMM) training on the training feature data to generate a plurality of Gaussian curves approximating a data distribution of the training feature data; and
generate a plurality of curve parameters of each of the Gaussian curves to be a categorizing feature of the corresponding audio category.

2. The audio categorization apparatus of claim 1, wherein the categorization processing circuit performs the audio framing according to an audio frame size and an overlapping size to generate a plurality of audio frames each having the audio frame size; and
wherein each of the audio frames in turn has an actual audio frame and an overlapping portion having the overlapping size, and the overlapping portion of each of the audio frames comprises a signal content the same as a front portion of a subsequent audio frame.

3. The audio categorization apparatus of claim 2, wherein the categorization processing circuit performs the feature extraction on the audio frame to generate the training feature data comprising zero-crossing rate (ZCR) data, spectral contrast data, chroma short-time Fourier transform (STFT) data, Mel spectrogram data or a combination thereof.

4. The audio categorization apparatus of claim 1, wherein the Gaussian mixture model training comprises performing a plurality of iterating processes on the training feature data according to a plurality of predetermined Gaussian curves to approximate the training feature data by the categorization processing circuit.

5. The audio categorization apparatus of claim 1, wherein the curve parameters comprise a weighting, a center position and a covariance matrix of each of the Gaussian curves.

6. The audio categorization apparatus of claim 1, wherein the audio categories comprise a music category, a speech category and an environmental sound category.

7. An audio categorization method comprising:
selecting one of a plurality of audio categories as a corresponding audio category from a plurality of training audio files categorized into a plurality of audio categories and retrieving the training audio files categorized to be the corresponding audio category to perform an audio framing and a feature extraction on the training audio files to generate a plurality of pieces of training feature data;
performing a Gaussian mixture model training on the training feature data to generate a plurality of Gaussian curves approximating a data distribution of the training feature data; and
generating a plurality of curve parameters of each of the Gaussian curves to be a categorizing feature of the corresponding audio category.

8. The audio categorization method of claim 7, further comprising:
performing the audio framing according to an audio frame size and an overlapping size to generate a plurality of audio frames each having the audio frame size;
wherein each of the audio frames in turn has an actual audio frame and an overlapping portion having the overlapping size, and the overlapping portion of each of the audio frames comprises a signal content the same as a front portion of a subsequent audio frame.

9. The audio categorization method of claim 8, further comprising:
performing the feature extraction on the audio frame to generate the training feature data comprising zero-crossing rate data, spectral contrast data, chroma short-time Fourier transform data, Mel spectrogram data or a combination thereof.

10. The audio categorization method of claim 7, wherein the Gaussian mixture model training comprises performing a plurality of iterating processes on the training feature data according to a plurality of predetermined Gaussian curves to approximate the training feature data by the categorization processing circuit.

11. The audio categorization method of claim 7, wherein the curve parameters comprise a weighting, a center position and a covariance matrix of each of the Gaussian curves.

12. The audio categorization method of claim 7, wherein the audio categories comprise a music category, a speech category and an environmental sound category.

13. An audio identification system comprising:
an audio categorization apparatus comprising:
a storage circuit configured to store a plurality of training audio files categorized into a plurality of audio categories; and
a categorization processing circuit configured to:
select one of the audio categories as a corresponding audio category and retrieve the training audio files categorized to be the corresponding audio category to perform an audio framing and a feature extraction on the training audio files to generate a plurality of pieces of training feature data;
perform a Gaussian mixture model training on the training feature data to generate a plurality of Gaussian curves approximating a data distribution of the training feature data; and
generate a plurality of curve parameters of each of the Gaussian curves to be a categorizing feature of the corresponding audio category; and
an audio identification apparatus comprising:
an audio retrieving circuit configured to retrieve an input audio; and
an identification processing circuit configured to:
perform the audio framing and the feature extraction on the input audio to generate a plurality of pieces of audio feature data;
compare the audio feature data of a plurality of to-be-identified sections of the input audio with the categorizing feature of all the audio categories to determine one of the audio categories that each of the to-be-identified sections belongs to; and
perform a statistics on the to-be-identified sections according to the audio categories that the to-be-identified sections belong to, so as to select one of the audio categories that most of the to-be-identified sections belong to as an identified audio category.

14. The audio identification system of claim 13, wherein the identification processing circuit performs the audio framing according to an audio frame size and an overlapping size to generate a plurality of audio frames each having the audio frame size; and
wherein each of the audio frames in turn has an actual audio frame and an overlapping portion having the overlapping size, the overlapping portion of each of the audio frames comprises a signal content the same as a front portion of a subsequent audio frame and each of the to-be-identified sections is the audio frame.

15. The audio identification system of claim 14, wherein the identification processing circuit performs the feature extraction on the audio frame to generate the training feature data comprising zero-crossing rate data, spectral contrast data, chroma short-time Fourier transform data, Mel spectrogram data or a combination thereof.

16. The audio identification system of claim 13, wherein for one of the to-be-identified sections to be operated, the identification processing circuit performs a probability density function (PDF) calculation on the audio feature data of the one of the to-be-identified sections to be operated according to the categorizing feature of each of the audio categories, so as to determine that the one of the to-be-identified sections to be operated belongs to one of the audio categories corresponding to a largest probability density value.

17. The audio identification system of claim 13, wherein the audio identification apparatus further comprises a function circuit configured to execute a predetermined function according to the identified audio category.

18. The audio identification system of claim 17, wherein the audio identification apparatus is a hearing aid apparatus and the function circuit is an equalization circuit to perform a speech enhancing function when the identified audio category is a speech category, to perform an audio enhancing function when the identified audio category is a music category and perform a noise reduction function when the identified audio category is an environmental sound category.

19. The audio identification system of claim 17, wherein the audio identification apparatus is a smart electronic apparatus and the function circuit is a control circuit to perform a voice control function, a speech-to-text function or a message notifying function when the identified audio category is a speech category and not to perform the voice control function, the speech-to-text function and the message notifying function when the identified audio category is a music category or an environmental sound category.
